(19) United States
(12) Patent Application Publication
(10) Pub. No.: US 2014/0060239 A1
(43) Pub. Date: Mar. 6, 2014

(54) VEHICLE PEDAL ASSEMBLY WITH SECURING DEVICE IN CASE OF IMPACT

(71) Applicant: MGI COUTIER, Champfromier (FR)

(72) Inventors: Pavan HEMMEGE VENKATAPPA, Conde sur Noireau (FR); Eric FERRETTE, Laize la Ville (FR); Jacques GUEVEL BADOU, Falaise (FR)

(73) Assignee: MGI COUTIER, Champfromier (FR)

(21) Appl. No.: 14/019,194

(22) Filed: Sep. 5, 2013

(30) Foreign Application Priority Data
Sep. 6, 2012 (FR) 1258349

(51) Int. Cl. G05G 1/327

(52) U.S. Cl. CPC G05G 1/327
USPC 74/512

(57) ABSTRACT

A pedal assembly includes a base on which at least one pedal is pivotably articulated, the pedal controlling an actuator, of the brake rod type, said pedal assembly including securing means designed to allow retraction of the pedal in the event of impact, and which are arranged so as to be able to cause, when activated dependent on a tilting lever, a freeing of the tilting axis of the pedal, through axial retraction of retractable bushes, and a captive transfer of said tilting axis relative to the base along at least one release component substantially transverse to the initial axial orientation of the tilting axis, so as to allow the release of the pedal while maintaining a functional tilting link between said pedal and the base, as well as a functional control link between the pedal and the actuator.

### TECHNICAL FIELD

The present invention relates to the general field of pedal assemblies designed to control any actuator.

The present invention more particularly relates to pedal assemblies designed to be onboard a vehicle, in particular a motor vehicle, to allow the driver to actuate and control one or more brake, acceleration and/or clutch controls.

### BACKGROUND

It is known to provide, within pedal assemblies equipping motor vehicles, securing devices making it possible to retract the pedal(s) when the vehicle undergoes a frontal impact, so as to avoid or at least limit the intrusion of said pedals in the passenger compartment, and consequently to minimize the risk of the driver being injured by said pedals.

To that end, it is in particular possible, as illustrated in document US-2004/0031350, to mount the pedal on a shaft supported by bearings axially pre-stressed by springs and kept in position, against the springs, by a bayonet lock, the bearings therefor comprising lugs which are engaged under the thickness of the metal sheet constituting the base of the pedal assembly and which are angularly offset relative to conjugated cuts of said metal sheet.

A tilting lever protrudes above the base and engages on the bearings, so as to be able, when said lever tilts, to bring the lugs aligned with the corresponding cuts.

Thus, when a sufficiently violent impact occurs to cause movement of the base of a sufficient amplitude for the pedal to collide with a stationary element of the passenger compartment provided to that end, such as the fire wall or the dashboard beam, the tilting of said lever frees the bearings, which are then axially ejected, thereby causing separation of the shaft from the base, and consequently falling of the pedal on the floor.

Although such a mechanism in fact makes it possible to preserve the volume of the passenger compartment in the area of the lower limbs of the driver in case of impact, and therefore to limit the risk of injuries, it nevertheless has certain drawbacks.

Firstly, the quantity and complexity of the parts making up said mechanism tend to complicate the manufacture and assembly of the pedal assembly, to the detriment of its cost and production rhythm.

Furthermore, this complexity, as well as the use of pre-stressing springs, may damage the effectiveness and operating reliability of said mechanism, due to increasing the friction stresses or risks of jamming between certain components. Yet such factors may oppose the proper activation of the system.

This may in particular be the case if a certain degree of aging affects the pedal assembly, in particular causing deformations of parts to appear due to creep, or causing loss of stiffness of the springs, or causing dirtying, which all represent potential sources of seizing.

Furthermore, the ejection of the bearings and the releasing of the pedal cause, in case of impact, an corresponding number of “flying” parts to appear, which may be transformed into projectiles that are dangerous for the occupants of the vehicle.

Furthermore, the releasing of the pedal itself causes a complete and definitive loss of the function normally controlled by said pedal, which may be detrimental to control of the vehicle during the accident, in particular when the braking capacity is thus prematurely and irretrievably lost.

Finally, to withstand the significant forces that are applied to the component parts of the known pedal assemblies, the said component parts of the known pedal assemblies are generally fairly massive and made from metal, and consequently relatively heavy and bulky.

### BRIEF SUMMARY

The invention therefore aims at resolving the aforementioned drawbacks and proposing a new type of pedal assembly that offers improved operating reliability and increased safety in case of impact.

The aims of the invention are achieved using a pedal assembly comprising a base on which at least one pedal is pivotably articulated, said pedal being designed to control the operation of an actuator, such as a brake rod, said pedal assembly being provided with securing means designed to allow placement of the pedal in a secure configuration in the event an impact situation is detected, said pedal assembly being wherein said securing means are arranged so as to be able to cause, when activated in an impact situation, freeing of the tilting axis relative to the base along at least one release component (direction) substantially transverse to the initial axial orientation of said tilting axis, so as to allow the release of the pedal while ensuring maintenance of a functional tilting link between said pedal and the base, the securing means therefor comprising at least one primary axis element, which is fusible or retractable in case of impact, on which the pedal is articulated during normal operation, and at least one auxiliary axis element, separate from the primary axis element and designed to provide an emergency pivot link for said pedal with the base once the primary axis element is broken or retracted.

Advantageously, the pedal assembly according to the invention thereby imparts increased security to the occupants of the vehicle, and in particular the driver.

Indeed, said pedal assembly first has a good ability to retract the pedal in case of impact, i.e., to modify the configuration of said pedal with respect to the base so as to better clear the space of the passenger compartment surrounding the pedal assembly, and thereby prevent any significant protruding intrusion of said pedal into said passenger compartment, thus limiting the risks of injury or trapping of the lower limbs.

Here, this retraction function is advantageously performed by a scheduled change of the tilting axis, which allows a transfer of the center of rotation of said pedal from a first region of the base to a second region of the base, preferably so as to allow more pronounced pushing in of the pedal, toward the floor or the fire wall separating the passenger compartment from the engine compartment, i.e., a pushing with a greater amplitude than during normal operation, thus making it possible to move said pedal away from the user.

More particularly, the invention makes it possible to physically uncouple the original link that initially exists between the pedal and the base, by destroying, taking off or preferably retracting the primary tilting axis, and to replace it, immediately and advantageously in response to a low activation force, with a second secondary tilting axis, i.e., a second functional link, which involves components that are different from the components involved in the first link.

This ability of simplified switching from one link to the other advantageously gives the means for securing the pedal assembly great sensitivity and a high performing speed.

Advantageously, the residual link that remains between the pedal and the base after activating the retraction, although guided to avoid any complete separation of the pedal, may be more loose or flexible than the original rigid pivot link, and may for example allow a certain degree of transverse sliding of the tilting axis, so as to oppose less resistance against the lower limbs which are situated near the pedal assemblies when the impact occurs.

Next, the preservation of a functional and guided tilting link between the base and the pedal after the impact, despite the retraction of said pedal, makes it possible to preserve operation, even deteriorated, of said pedal, and thereby to preserve a certain, intuitive control of the actuator.

In particular, it is thus possible to preserve a certain capacity to control the vehicle, and in particular a braking capacity, after an initial impact, which may contribute to limiting the consequences of the accident since easier and better controlled immobilization of the vehicle is thus enabled.

Additionally, keeping a persistent attachment between the base and the pedal, and more preferably the absence of ejection or rupture of the mere part of the pedal assembly during activation of the securing means according to the invention, makes it possible to avoid the inopportune release of component parts of the pedal assembly, which would otherwise be transformed into blunt or sharp inertial projectiles, for example if the damaged vehicle swerves, rolls over or strikes an obstacle.

The preservation of the integrity of the pedal assembly according to the invention, and more particularly the retention of the components of the pedal assembly achieved by the securing means according to the invention, therefore significantly improves the security of the occupants of the vehicle.

Preferably, the at least one primary axis element is formed by at least one retractable bush, on which the pedal is rotatably articulated during normal operation and which is designed to retract axially, in case of impact, depending on an triggering member, so as to free itself from the pedal.

Such an arrangement in particular allows a quick and safe release of the primary axis, which opposes little resistance to the activation of the securing means.

Preferably, the triggering member includes a lever that is mounted tilting on the base and coupled to a maneuvering rod on which the retractable bush(es) are engaged, said maneuvering rod being arranged to be able to control the axial return of the retractable bush(es).

Such an arrangement, which is particularly compact, makes it possible, among other things, to actuate the bushes easily, while preferably keeping them captive.

Preferably, the retractable bush(es) are slidingly mounted in the base and are outwardly provided with guide surfaces, of the flat, lug or spline type, arranged to cooperate with the walls of the base so as to block the rotation of said bushes around their axis (X₁X₁′) within said base, the retractable bush(es) each being axially engaged on the maneuvering rod, said maneuvering rod being provided with a helical thread designed to cooperate with a helical groove with a conjugated shape that is hollowed inside the considered bush, such that the lever can rotate the maneuvering rod and thus control the axial return, by screwing along the maneuvering rod, of the retractable bush(es).

According to another possible alternative, the retractable bush(es) are mounted axially slidingly on the maneuvering rod and inwardly provided with guide surfaces, of the flat, lug or spline type, arranged to cooperate with conjugated walls of said maneuvering rod so as to secure said bush(es) in rotation with said maneuvering rod around their shared axis (X₁X₁′), the retractable bush(es) being provided, on their radially outer surface, with a helical thread designed to cooperate with a helical groove with a conjugated shape that is hollowed inside said base, such that the lever can rotate the maneuvering rod and the bush(es) together and thereby control the axial return, by screwing in the base, of the retractable bush(es).

In either case, the return by screwing makes it possible to implement a simple, reliable and robust mechanism, which is also compact and inexpensive to produce.

Preferably, the pedal is articulated on the base using a yoke whereof the two branches cooperate, on either side of said base, with a first primary axis element and with a second primary axis element, coaxial to the first primary axis element, respectively, and in that the securing means are arranged so as to be able to draw, preferably simultaneously, the first and second primary axis elements toward each other, so as to retract them inside the base, between the branches of the yoke.

Advantageously, using a yoke makes it possible to axially spread the seating of the pedal, and thus to improve the robustness, stability and precision of the pivot link with the base.

The release movement of the bushes toward the inside of the base ensures compact and safe activation of the securing mechanism, without causing elements to protrude or be ejected into the passenger compartment, thereby improving, inter alia, the ability to retain the bushes within the pedal assembly.

Preferably, the at least one auxiliary axis element is formed by a journal secured to the pedal, preferably integral with the arm of said pedal, and which is housed in a guide slot hollowed out from one of the outer lateral faces of the base.

Such an arrangement in particular allows a particularly simple, compact and light embodiment of the auxiliary axis, while ensuring effective retention of the pedal on the base during securing operation.

More particularly, the left and right branches of the yoke preferably respectively bear a first journal and a second journal that are coaxial, oriented toward the base, and respectively engaged in a first left guide slot and a second right guide slot each hollowed on one of the corresponding left and right lateral faces of said base, said first and second journals each being pierced, along their generator axis, with a bore designed to receive and guide in rotation, during normal operation, the corresponding primary axis element so as to authorize and guide the tilting of the pedal, and in that the radially outer rim of each of said journals preferably forms a cylindrical rim with a substantially circular base, coaxial to the bore, the diameter of which substantially corresponds to the width of the guide slot in which the journal is engaged, such that, in case of removal of the corresponding primary axis elements, the journals can slide transversely to their generator axis, captive along their respective slot, while preserving a degree of rotational freedom around said generator axis.

In particular, the stability and robustness of the pedal assembly are thus improved, while preserving compactness of said pedal assembly and activation and operating reliability of said pedal assembly during securing operation.

According to one alternative embodiment, the arm of the pedal comprises two sets of articulation members installed on the pedal at a distance one from the other, the articulation members of the first set, of the bore type, physically defining a first primary axis (X₁X₁′) on the pedal and being designed to cooperate with the primary axis element(s) so as to initially allow the articulation of the pedal around said primary axis (X₁X₁′), while on the other hand, the articulation members of the second set, of the journal type, define, on the same pedal, a second reserve auxiliary axis (X₂X₂′), at a preferably fixed transverse distance from the first primary axis (X₁X₁′), and said articulation means of the second set being arranged to cooperate from the beginning with the base, jointly with the articulation members of the first set, so as to be able to take over instantaneously for the latter, and thus automatically replace the primary axis (X₁X₁′) with the auxiliary axis (X₂X₂′), when the retraction or destruction of the primary axis elements occurs.

Preferably, the pedal is provided with a coupling member designed to functionally link the pedal to the actuator and the securing means are arranged so as to allow the preservation, after they are activated in case of impact, of said functional control link between the pedal and the actuator.

Thus, it is possible, even in case of impact, to preserve the main function of the pedal assembly, even in deteriorated mode, thus enabling the driver keeping a certain control of the vehicle in a critical situation.

The invention also relates as such to a subassembly for retracting the tilting axis for a pedal assembly, said subassembly comprising:
a radial lever coupled, preferably by flats or splines, to the central segment of the maneuvering rod, so as to be able to rotate said maneuvering rod around its main axis, substantially transverse to the lever,
a first bush that is engaged, along its generator axis, on the maneuvering rod and having, either on its radially inner face or on its radially outer face, a helical linking member designed to allow the conversion of the rotational movement of the lever into an axial translational movement of said first bush,
a second bush that is engaged, along its generator axis, on the maneuvering rod across from the first bush and having, either on its radially inner face or on its radially outer face, a helical linking member designed to allow the conversion of the rotational movement of the lever into an axial translational movement of said second bush, in a direction opposite that of the first bush.

More particularly, such a subassembly may comprise:
a radial lever coupled, preferably by flats or splines, to the central segment of the maneuvering rod, so as to be able to rotate said maneuvering rod around its steering axis, substantially transverse to said lever,
as well as a first bush engaged, along its generator axis, in a helical link on the first end of said maneuvering rod, the radially outer surface of said first bush on the one hand having articulation surfaces that follow at least one cylinder portion with a substantially circular base, so as to embody a first primary axis element making it possible to articulate the pedal on the base of said pedal assembly, and on the other hand one or more guide surfaces, of the flat or spline type, designed to cooperate with the base of the pedal assembly to block the rotation and allow the axial translation of said first bush, the radially inner surface of said first bush furthermore being hollowed out by a helical groove on which a conjugated helical thread meshes, said thread being supported by the corresponding end segment of the maneuvering rod, so as to make it possible to force the translation of said first bush toward the central segment when the lever rotates the maneuvering rod relative to the first bush,
as well as a second bush that is slipped, along its generator axis, in a helical link on the second end of said maneuvering rod, the radially outer surface of said second bush on the one hand offering one or more articulation surfaces that follow at least one cylinder portion with a substantially circular base, so as to embody a second primary axis element for articulating the pedal, coaxial to the first primary axis element, and on the other hand one or more guide surfaces, of the flat or spline type, designed to cooperate with the base to block the rotation and allow the axial translation of said second bush, the radially inner surface of said second bush furthermore being hollowed out by a helical groove on which a conjugated helical thread meshes, said helical thread being supported by the corresponding end segment of the maneuvering rod, but having a reverse thread angle with respect to the thread angle of the thread which cooperates with the first bush, thus making it possible to force the translation of the second bush in opposition to the first bush.

The invention lastly relates to a vehicle, such as a motor vehicle, equipped with a pedal assembly, preferably a brake pedal assembly, according to one or another of the considered alternatives.

### BRIEF DESCRIPTION OF THE DRAWINGS

Other aims, features and advantages of the invention will appear in more detail upon reading the following description, as well as using the appended drawings, provided purely for information and non-limitingly, in which:

FIG. 1 shows an exploded perspective view of an alternative embodiment of a pedal assembly according to the invention.

FIGS. 2, 3 and 4 show side views of the pedal assembly of FIG. 1, respectively with the pedal articulated on its primary axis and being in the raised angular position, then with said pedal articulated on its primary axis in normal operation and being in a pushed angular position, and finally with the pedal articulated on its auxiliary axis, after activation of the securing means, and being in an angular position pushed further in.

FIGS. 5 and 6 show cross-sectional views, in the frontal plane of the base, of the pedal assembly of FIGS. 1 and 4, in the normal configuration and then in the securing configuration respectively.

FIG. 7 shows a perspective view of a subassembly for axial retraction of the primary tilting axis of the pedal that may be implemented within a pedal assembly to ensure the securing thereof.

FIG. 8 shows a top view of one example of a pedal intended for the pedal assembly of FIGS. 1 to 6 and provided with an articulation yoke that has journals designed to form secondary axes supporting the pedal on the base after the pedal assembly is secured.

FIG. 9 shows a top view of the pedal assembly of FIGS. 1 to 6, provided with the pedal of FIG. 8.

FIGS. 10 and 11 show frontal cross-sectional diagrammatic views of possible embodiments for captive guiding of the pedal on the base.

### DETAILED DESCRIPTION

The present invention relates to a pedal assembly 1, of the control pedal assembly type, designed to actuate any mechanism, and more particularly a pedal assembly designed to be installed in a vehicle, in particular a motor vehicle, in view of controlling one or more, optionally power-assisted, acceleration, clutch and/or braking controls.

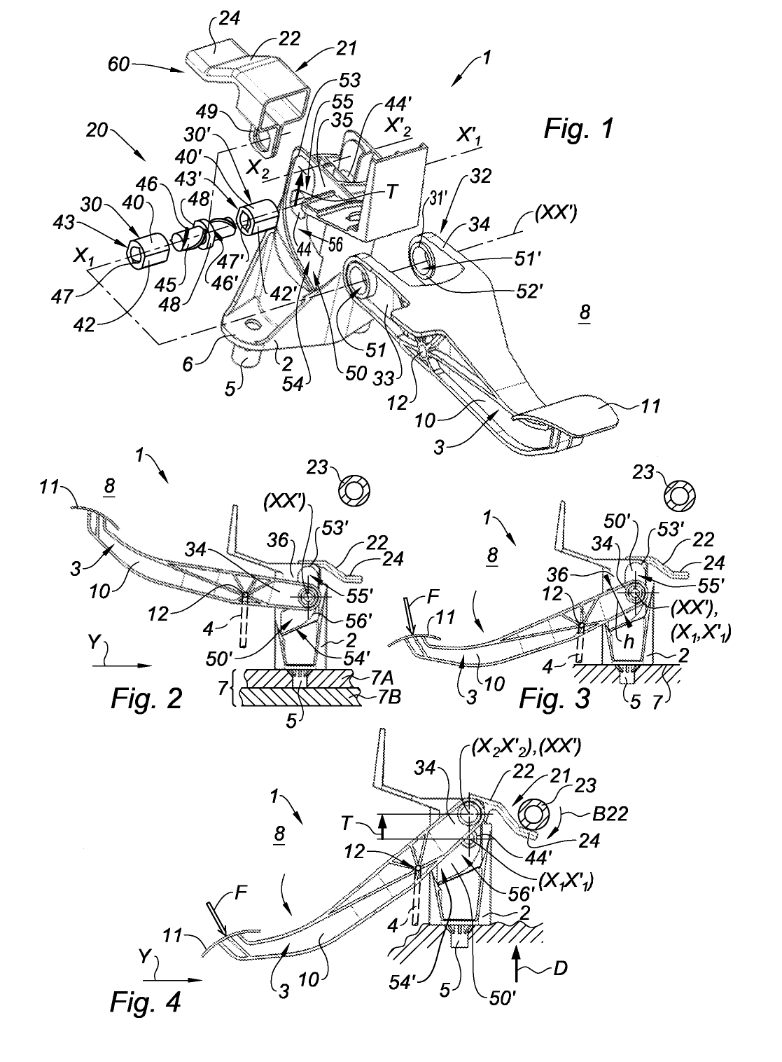

As in particular illustrated in FIGS. 1 to 4, the pedal assembly 1 comprises a base 2, on which at least one pedal 3 designed to control the operation of an actuator 4, of the brake rod, clutch cable, accelerator, or equivalent type, is pivotably mounted around a tilting axis.

Advantageously, the base will be provided with fastening members, such as bushings 5, provided with passages for anchoring screws, said bushings 5 may for example protrude below a base plate 6, which is preferably planar, and by which the base may bear on a receiving support 7, such as the fire wall of the vehicle.

As illustrated in FIG. 2, the bushings 5 may advantageously form spacers designed to pass through and offset the thickness of a covering 7A, of the carpet type, covering the rigid and supporting body portion 7B of the receiving support 7, so as to obtain a stable and robust seat directly on said body portion 7B.

Preferably, the receiving support 7 will be formed by an inclined portion of the fire wall of the vehicle.

The pedal will preferably comprise an arm 10, the first end of which is designed to be pivotably articulated on the base 2, and the second end of which may bear a pad 11, designed to receive a control force F, in principle exerted by the user's foot, said force being capable of driving the tilting and pushing in of the pedal 3 against the actuator 4, said actuator which will thus preferably be stressed in compression, but may of course alternatively be stressed in traction.

By convention and for ease of the description, it will be considered that the foreseeable control force F is oriented in the descending direction, and preferably in a substantially vertical direction, as illustrated in FIGS. 3 and 4.

The pad 11, which is preferably wider than the body of the arm 10, may be formed by a curved plate, preferably fixed in the upper part of said arm 10, and which may be integral with the latter part.

Said pad 11 may optionally be provided with a non-skid fitting and/or shapes, such as ridges or a sleeve made from an elastomer material.

Furthermore, the arm 10 will preferably advantageously comprise a coupling member 12 designed to receive the end of the actuator 4. Said coupling member 12 may for example be formed by a transverse circular eyelet, preferably reinforced by ribs, which penetrate inside the body of the arm 10, or pass through the latter, so as to be able to receive a hook or stirrup provided at the end of said actuator 4.

In order for the arm 10 to be able to convert the control force F into a compression force exerted on the actuator 4, while providing clear access to the pedal, and more particularly clear access to the pad 11, said coupling member 12 will preferably be situated in an intermediate area of the arm closer to the tilting axis than the end that supports the pad 11.

The arm 10 may of course have any other suitable shape and dimensions. It may in particular extend globally straight or curved, perpendicular to the tilting axis or on the contrary oblique, as in particular illustrated in FIGS. 8 and 9, so as to axially offset the pad 11 on the abscissa along said tilting axis, thus off-centering said pad relative to the base 2.

Furthermore, the present invention also relates to a vehicle, and in particular a motor vehicle, preferably with wheels, for example designed for the individual or group transport of people or goods, which is equipped with a pedal assembly 1, preferably a brake pedal assembly, according to the invention.

According to the invention, the pedal assembly 1 is provided with securing means 20 designed to allow the pedal 3 to be placed in a secure configuration in the event an impact situation is detected, and more particularly in the event a frontal impact situation is detected.

The detection of the impact situation and the activation of the securing means 20 may be done according to predefined criteria corresponding to a predetermined impact intensity and/or vehicle deformation situation, and depending on a suitable triggering member 21.

Although it is not ruled out to implement an triggering member 21 that is for example motorized or pyrotechnic, comprising an electronic control circuit associated with sensors such as strain gauges, the triggering member 21 will preferably be mechanical, and of the passive type, for the sake of simplicity and reliability.

More particularly, said triggering member 21 may be formed by a lever 22, or “switch”, designed to collide, in case of sufficient deformation of the vehicle, and more particularly deformation oriented toward the passenger compartment 8, of the engine compartment and/or the front of the fire wall 7, with a stationary obstacle 23 provided on a robust, less deformation-sensitive portion of the chassis or body of the vehicle, for example such as a portion of the fire wall, the dashboard beam, etc.

Said obstacle 23, initially placed by construction at a distance back from the lever 22, away from said lever in normal operation (FIGS. 2 and 3), will advantageously come into contact with said lever 22, preferably at a paddle 24 provided for this purpose and protruding from the base 2, when said lever 22, more generally the pedal assembly 1, comes closer to and collides with said obstacle 23 due to the deformation D of its support 7 (FIG. 4) that results from the impact. The tilting B22 of said lever 22 that will result therefrom will then cause, cleanly and reliably, the activation of the securing means 20, and the retraction of the pedal 3.

According to one alternative embodiment that is not shown, the lever 22 may be connected to the remote obstacle 23 by a mechanical transmission member, such as a control rod.

Such an arrangement would advantageously make the activation of the securing means 20 more sensitive, faster and more reliable, in particular by avoiding the activation hazards related to the hazards of the deformation of the vehicle during the accident.

Upon the activation of the securing means 20, the pedal 3, and more particularly the arm 10 and the pad 11, may advantageously perform, as illustrated in FIG. 4, a retraction movement, under the effect of their own weight or under a voluntary control force F maintained during the accident.

Advantageously, the pedal 3, and more particularly the free end of the arm 10 and the pad 11, may thus move relative to the base 2, and more generally relative to the free volume of the passenger compartment 8, following said retraction movement, so as to stay away or move away from the lower limbs of the driver, and thereby perform a clearing movement that prevents any dangerous intrusion thereof into said volume of the passenger compartment 8.

Said movement may advantageously assume the form of a collapse or accentuated tilting of the pad 11 toward the floor and/or the fire wall.

According to the invention, the securing means 20 are arranged so as to be able to cause, when activated in an impact situation, a release of the tilting axis of the pedal 3 and a captive transfer T of said tilting axis relative to the base 2, as illustrated in FIG. 4, according to at least one release component (direction) substantially transverse to the initial axial orientation of said tilting axis, so as to allow the release of the pedal 3 while ensuring maintenance of a functional tilting link between said pedal 3 and the base 2.

Thus, the tilting axis of the pedal 3 may be moved, substantially parallel to itself, from a first position (X₁X₁′) to a second position (X₂X₂′), separate and remote from the first position, thus allowing the pedal 3, and more particularly the arm 10, to withdraw relative to the passenger compartment 8 and/or to intensify its tilting amplitude.

More particularly, the instantaneous tilting axis may thus be spontaneously offset, and more particularly slide on the base 2, following a captive, controlled, bounded and predetermined trajectory, generally going in the direction of the natural accentuation of the pushing in of the pedal 3.

This offset trajectory may advantageously be defined to offer the safest possible retraction position of the pedal 3 in case of impact, for the considered vehicle.

In particular, said offset trajectory may be oriented so as to allow a movement, and more particularly pushing in, of the pad 11, and the corresponding end of the arm 10, toward the front of the vehicle, toward the engine compartment.

Depending on the incline of said support 7 on the one hand, and depending on the orientation of the base 2, for example normal to said support, on the other hand, the trajectory followed for that purpose by the tilting axis during its transfer may be oriented preferably toward the rear of the vehicle and upward, according to at least, or even mainly, one component (direction) that may be substantially normal to the support 7.

Advantageously, the persistence of the pivot link, embodied around the tilting axis, and linking the pedal 3 to the base 2, makes it possible not only to avoid dislocation of the pedal assembly and ejection of free parts into the passenger compartment, by preserving the attachment of said pedal, but also to maintain a degree of functional rotational freedom of said pedal 3 on said base 2, and to thereby preserve operation of the control of the actuator 4, and more particularly the brakes, even when said operation may optionally be deteriorated, as it is more difficult or less comfortable to control.

Preferably, the securing means 20 comprise at least one primary axis element 30, 30′ that is fusible or retractable in case of impact, on which the pedal 3 is articulated during normal operation, and at least one auxiliary axis element 31, 31′, separate from the primary axis element 30, 30′ and designed to provide said pedal 3 with an emergency pivot link with the base 2 once the primary axis element 30, 30′ is broken or retracted.

Thus, the or preferably all (here two) of the primary axis elements 30, 30′ embody the primary tilting axis (X₁X₁′) on which the pedal swivels during normal operation, while the or preferably all (here two) of the auxiliary axis elements 31, 31′ embody a secondary tilting axis (X₂X₂′), which takes over for the primary axis in case of impact so as to allow the pedal 3 to preserve its degree of freedom in rotation around an offset axis.

Advantageously, the primary 30, 30′ and secondary 31, 31′ axis elements are initially arranged so as not to interfere with each other, and thus to be able to alternate their participation, which is active but separate, in the articulation of the pedal 3 depending on whether the situation is normal or securing has been activated, respectively.

Furthermore, irrespective of the rest of the operation of the pedal assembly, and as shown in particular in FIGS. 1 and 5 to 9, the pedal 3 is preferably articulated on the base 2 using a yoke 32.

Advantageously, during normal operation, the two left 33 and right 34 branches of said yoke 32 cooperate, preferably on either side of said base 2, said base being preferably positioned in the air gap of said yoke 32, with a first primary axis element 30 and with a second primary axis element 30′, which is coaxial to the first primary axis element 30, respectively.

Such an arrangement advantageously imparts considerable robustness and excellent stability to the pivot link, by maximizing the expanse of the contact and guide surfaces, and limiting the effects of frictional jamming and displacement of the arm 10 related to the functional clearance, even when the machining tolerances are not very strict.

Furthermore, such an arrangement makes it possible, if needed, to widen the section of the arm 10, in particular at said arm's root, and thus to reinforce the pedal 3, in particular against flexion or torsion stresses.

Owing, inter alia, to the structural reinforcement of the pedal assembly, which may in spite of everything preserve a low overall bulk, it is possible to consider making said pedal assembly 1, and more generally the pedal 3 and/or the base 2, from one or more light and easy-to-shape materials, such as thermoplastic polymers, which may or may not be filled with fibers, or plastic matrix-based composite materials that may or may not be reinforced with woven fibers, or alloys of light metals of the aluminum or magnesium type, while preserving the robustness and rigidity of those parts.

According to one preferred alternative embodiment, the pedal 3 and/or the base 2, respectively, will each be made in a single piece, for example by injection molding.

Additionally, if the base 2 is placed between the branches 33, 34, preferably with low axial clearance, said base 2 may advantageously form a bidirectional axial abutment which allows, through a simple and compact structure, a precise and effective placement, and retaining in the axial position, of the pedal 3.

Furthermore, in order to facilitate the assembly of the pedal 3 and improve the quality of the rotational guiding, the outer bearing faces 35, 36 of the base 2, and more particularly the lateral cheeks of said base 2, on which the branches 33, 34 are in sliding contact, are preferably, like the corresponding contact surfaces of said branches 33, 34, at least partially or even in their majority substantially planar and parallel to each other, and substantially normal to the tilting axis.

Particularly preferably, the securing means 20 are arranged so as to be able to draw, preferably simultaneously, the first and second primary axis elements 30, 30′ toward each other, so as to retract them inside the base 2, between the branches 33, 34 of the yoke 32, as illustrated in FIG. 6 and indicated by arrows R30, R30′ at the bottom of FIG. 7.

Advantageously, such an inward movement makes it possible to give the pedal assembly 1 a very compact structure, the central volume of the barrel forming the base 2 being used as a space for clearing, then storing the primary axis elements 30, 30′.

Furthermore, said movement advantageously avoids the protruding expulsion or ejection of said primary axis elements 30, 30′ in the passenger compartment 8.

According to one preferred alternative embodiment, as in particular shown in FIGS. 1 and 7, at least one, and preferably each, primary axis element 30, 30′ is formed by at least one retractable bush, on which the pedal 3 is rotatably articulated during normal operation, and which is designed to retract axially, in case of impact, depending on the triggering member 21, so as to free itself from the pedal 3.

For convenience of the description, said primary axis elements 30, 30′ may therefore be compared to bushes hereafter.

In order to embody the primary axis of rotation (X₁X₁′) on which said bushes 30, 30′ are advantageously centered, the radially outer surface of each bush 30, 30′ will preferably offer one or more articulation surfaces 40, 41, 40′, 41′ that form at least one cylinder portion with a substantially circular base, and on which the pedal 3, and more particularly corresponding cylindrical bores 51, 51′ pierced in each of the branches 33, 34 of the yoke 32, may swivel, during normal operation, preferably directly as journal bearings.

Advantageously, in case of impact, a suitable retraction mechanism, placed to depend on the triggering member, and whose motion is preferably driven by said triggering member, performs the axial extraction of the bush, along the stationary primary axis (X₁X₁′), until said bush is released by being completely extracted from the corresponding bearing of the pedal 3, said pedal thus being freed of its first tilting axis, here preferably by adding a least one degree of translational freedom transverse to said axis, so that said pedal has its pivot link switched onto the auxiliary axis elements 31, 31′.

For this purpose, the triggering member 21 may preferably include a lever 22 that is tiltably mounted on said base 2 and coupled to a maneuvering rod 45 on which the retractable bush(es) 30, 30′ are engaged, said maneuvering rod 45 being arranged to be able to control the axial return of the retractable bush(es) 30, 30′.

More particularly, according to one alternative embodiment, the retractable bush(es) 30, 30′ are preferably slidingly mounted in the base 2 and are outwardly provided with guide surfaces 42, 43, 42′, 43′, of the flat type, as illustrated in FIGS. 1 and 7, or of the lugs or splines type, said guide surfaces being arranged to cooperate with the walls of the base, and more particularly with the inner walls of orifices 44, 44′ with conjugated shapes passing through the wall of said base 2, so as to block the rotation of said bushes around their axes, here the primary axis (X₁X₁′), within said base 2.

Furthermore, said retractable bushes 30, 30′ are preferably each axially engaged onto a maneuvering rod 45, capable of forcing their return by axial translation, said maneuvering rod 45 therefor preferably being provided with a helical thread 46, 46′ designed to cooperate with a helical groove 47, 47′ with a conjugated shape hollowed out inside said considered retractable bush 30, 30′.

Advantageously, the triggering member 21 may then include, as was considered above, a lever 22 that is tiltably mounted on the base 2 and coupled to the maneuvering rod 45, preferably by a pierced tab 49 engaging flats 48 machined for example on a central collar of said rod 45, so as to be able to rotate said rod 45 and thus control the axial return, here preferably toward the inside of the base 2, by screwing, here along said maneuvering rod 45, of the retractable bush(es) 30, 30′.

Of course, the screwing device may be arranged inversely, the connection by helical threading being done between the bushes 30, 30′ and the base 2, rather than between the bushes 30, 30′ and the maneuvering rod 45.

According to such an alternative, the retractable bush(es) 30, 30′ are mounted axially slidingly on the maneuvering rod 45 and inwardly provided with guide surfaces, of the flat, lug or spline type, arranged to cooperate with conjugated walls of said maneuvering rod 45 so as to secure in rotation, around their shared axis (X₁X₁′), said bushes 30, 30′ with said maneuvering rod 45, while allowing the sliding of said bushes on said maneuvering rod.

The retractable bush(es) 30, 30′ are then provided, on their radially outer surface, with a helical thread designed to cooperate with a helical groove with a conjugated shape that is hollowed out inside the base 2, such that the lever 22 can securely rotate the maneuvering rod 45 and the bushes 30, 30′ and thereby control the axial return, by screwing, here in the base 2, of the retractable bush(es) 30, 30′.

Advantageously, the extraction by screwing of the retractable bushes 30, 30′ along the primary articulation axis (X₁X₁′), by drawing said bushes closer one to the other, guarantees a reliable, balanced activation of the securing means 20, in particular between the left and right bearings of the articulation, without any jerk.

Furthermore, such an arrangement minimizes the force that must be produced on the triggering member 21 to release the pedal 3, insofar as in particular it is no longer necessary to proceed with the destruction of any fusible element or to counter any tightening force within the pedal assembly 1, since it suffices to impart, via the lever arm procured by the lever 22, a torque which is sufficient to be converted into sliding traction by the helical link.

Advantageously, the triggering member 21 is thus relatively sensitive, and therefore particularly effective.

Of course, the pitch of the thread 46, 46′ will advantageously be sized to make it possible to associate the foreseeable angular movement of the lever 22, and therefore of the maneuvering rod 45, in case of impact, with an axial travel of the retractable bush 30, 30′ that is at least equal to the initial length of penetration of said retractable bush 30, 30′ in the branch 33, 34 of the yoke, and more particularly in the bore 51, 51′.

It will also be noted that, according to one particularly advantageous feature, the invention makes it possible to have a same shared axis, in this case the primary tilting axis (X₁X₁′), that supports both on one hand the primary axis elements 30, 30′ forming the articulation of the pedal 3 on the base 2 and on the other hand the members, in this case the maneuvering rod 45 bearing the lever 22, allowing the retraction of said primary axis elements; this is possible by means of a coaxial arrangement that allows them to share said axis.

In particular, according to what may constitute an invention on its own, the tilting axis of the triggering member 21, here the tilting axis of the lever 22, and the initial primary tilting axis (X₁X₁′) of the pedal 3 on the base 2 are advantageously geometrically the same.

The invention thus makes it possible to vary and multiply the functions of the pedal assembly 1 in a particularly reduced volume, by saving on parts, raw material, and space.

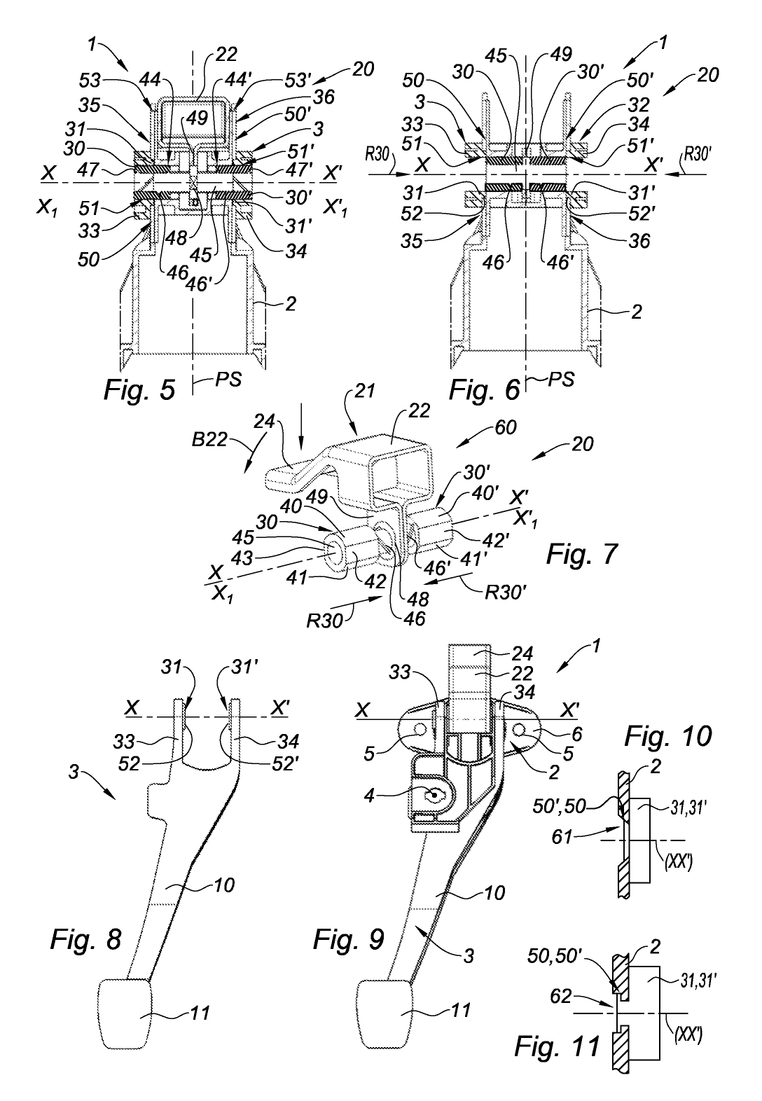

Furthermore, as illustrated in FIGS. 5 to 7, the arrangement of the bushes 30, 30′, the lever 22, and/or the maneuvering rod 45, or even more generally the base 2, will preferably be substantially symmetrical relative to the sagittal plane PS of the mechanism, said plane being normal to the tilting axis, the characteristics of the right side being able to be deduced, if applicable, mutatis mutandis from those of the left side and vice versa.

In particular, the threads 46, 46′, each provided at one of the ends of the maneuvering rod 45, preferably have a pitch which is equal but of reversed angle, so as to be able to simultaneously recall the two retractable bushes toward each other, causing them to converge toward the central collar of the maneuvering rod 45, and toward the sagittal plane PS.

Likewise, the retractable bushes 30, 30′ will preferably have identical dimensions, and in particular an identical overall diameter.

Furthermore, according to one preferred feature that may constitute an invention on its own, at least one, and preferably each, auxiliary axis element 31, 31′ is formed by a journal secured to the pedal 3, preferably integral with the arm 10 of said pedal 3, and which is housed in a guide slot 50, 50′ hollowed from one of the outer lateral faces of the base, and more particularly which is hollowed and opens on the corresponding outer bearing surface 35, 36.

Out of convenience for the description, the auxiliary axis elements 31, 31′ may therefore be likened to journals hereafter.

More particularly, the left 33 and right 34 branches of the yoke 32 preferably respectively bear a first journal 31 and a second journal 31′ that are coaxial, oriented toward the base 2, i.e., preferably protruding in the air gap of the yoke 32, and respectively engaged in a first left guide slot 50 and a second right guide slot 50′ each hollowed out on one of the corresponding left 35 and right 36 side faces of said base 2.

Preferably, said first and second journals 31, 31′ are each pierced, along their generator axis, with a bore 51, 51′ designed to receive and guide in rotation, during normal operation, as illustrated in FIG. 5, the corresponding primary axis element (X₁X₁′), and more particularly the corresponding bush 30, 30′, so as to allow and guide the tilting of the pedal 3.

Additionally, the radially outer rim 52, 52′ of each of said journals 31, 31′ preferably forms a cylindrical rim with a substantially circular base, coaxial to the bore 51, 51′, the diameter of said rim substantially corresponds to the width of the guide slot 50, 50′ in which said journal is engaged, such that, in case of removal of the corresponding primary axis elements (retractable bushes) 30, 30′, the journals 31, 31′ can slide transversely to their generator axis, and therefore in particular relative to the primary tilting axis (X₁X₁′), in a captive manner along their respective slot 50, 50′, while preserving a degree of relational freedom around said generator axis.

Preferably, the outer diameter of said journals 31, 31′ is strictly smaller than the height h of the branch 33, 34 of the yoke on which the concerned journal is installed and protrudes, so as to form a shouldered structure.

The journals 31, 31′ thus advantageously forming protuberances, here entering into the air gap of the yoke 32, their wheel rims 52, 52′ can cooperate, during retraction of the bushes 30, 30′ and therefore unlocking of the pedal 3, with the transverse edges of the slots 50, 50′, which limit the travel of said journals 31, 31′ in the space that said edges delimit, such that the pedal 3 remains connected to the base 2, and guided thereon.

However, it is also possible to consider the outer diameter of one and/or the other of the journals 31, 31′ being equal to, or even greater than the height h of the branch 33, 34 on which said journal is installed.

According to one alternative embodiment that is not shown, the arm 10, and more particularly the yoke 32, may comprise first and second sets of articulation members, installed on the pedal 3 away from one another, the articulation members of the first set, of the bore type, physically defining, on the pedal 3, a first primary axis (X₁X₁′) and being designed to cooperate with the primary axis element(s) 30, 30′ so as to initially allow the articulation of the pedal 3 around said primary axis (X₁X₁′), while on the other hand, the articulation members of the second set, of the journal type 31, 31′, define, on the same pedal 3, a second reserve auxiliary axis (X₂X₂′), at a transverse distance, preferably fixed, from the first primary axis (X₁X₁′), and arranged to cooperate from the beginning with the base, jointly with the articulation members of the first set, and to be able to instantaneously take over for the latter, and thus automatically replace the primary axis (X₁X₁′) with the auxiliary axis (X₂X₂′), during retraction or destruction of the primary axis elements.

In other words, the first and second sets of articulation members may, instead of being positioned coaxially, as it is notably the case for the bores 51, 51′ (first set) and the wheel rims 52, 52′ of the journals 31, 31′ (second set) of FIGS. 5 and 6, rather be transversely separated, in a non-coaxial arrangement, along the arm 10 and more particularly along the yoke 32, due to a stepped installation of said first and second sets of articulation members depthwise over said yoke 32.

The arm 10, and more particularly the yoke 12, may thus include a first pair of articulation members on the one hand, of the bore type passing through the branches of the yoke, and designed to cooperate with the bushes 30, 30′ to form the primary axis (X₁X₁′), and on the other hand apparent journals 31, 31′, which are off-centered transversely relative to said bores, and designed to form the auxiliary axis (X₂,X₂′).

Thus, the axis transfer may take place in the form of an instantaneous switch, or “axis jump”, between the retracted primary axis (X₁X₁′) and the auxiliary axis (X₂X₂′) which is remote from the first axis from the beginning, due to construction.

Of course, the off-centered journals 31, 31′ will be arranged such that, as long as the bushes 30, 30′ are engaged, i.e., as long as the pedal is articulated on its primary axis (X₁X₁′), said journals can cooperate with the base 2, for example by sliding in circular slots centered on the primary axis (X₁X₁′), without hindering the tilting around said primary axis.

Preferably, the guide slot(s) 50, 50′, preferably arranged symmetrically relative to the sagittal plane PS of the base, will be blind, i.e., transversely closed at one of their ends, preferably the end furthest from the pad 11, the passenger compartment 8 and therefore the driver, in order to form a stop 53, 53′ against the transverse movement, hereby sliding, of the journals 31, 31′ when the latter are released in case of impact.

Advantageously, these stops 53, 53′, preferably each formed by a half-circle-shaped wall element with a diameter substantially equal to the width of the slot 50, 50′ and therefore substantially equal to the diameter of the wheel rim 52, 52′, to within the articulation clearance, will define, as shown in FIGS. 1 to 4, the second position (X₂X₂′) of the tilting axis, i.e., the unique or preferred location of the auxiliary axis, that the pedal 3 may adopt, advantageously deterministically and/or reproducibly, after activation of the securing means, possibly under the effect of its own weight or, more possibly, under the effect of applying a control force F.

Preferably, the bottom of the slots 50, 50′ will be secant to the main axis (X1X1′), and more particularly normal to the main axis (X1X1′), and therefore parallel to the corresponding lateral bearing face 35, 36 of the base 2.

This bottom, mainly solid, may advantageously offer support as needed, here planar, for the edges of the journals 31, 31′, and more particularly the edges of the bearing rims, said support in particular contributing to keeping the yoke 32 axially in position, at a substantially constant abscissa, during tilting of the pedal 3 and during the transfer T.

Depending on the selected design, this bidirectional axial stopping role may be performed either preferably by the {yoke branches 33, 34/outer lateral walls 35, 36} pair, or secondarily, by the { rim edges 52, 52′/slot bottom 50, 50′} pair.

Said slots 50, 50′ will additionally be arranged so as to cover the passage and guide orifices 44, 44′ of the retractable bushes 30, 30′, the width of said slots 50, 50′, strictly larger than that of said retractable bushes, allowing said slots to contain and frame said orifices 44, 44′ while leaving enough space around said orifices to allow the placement, then the movement of the rims 52, 52′.

Purely for information, the outer diameter of the journals 31, 31′, and therefore the rims 52, 52′, may be substantially comprised between 10 mm and 50 mm, the width of the slots 50, 50′ substantially comprised between 15 mm and 60 mm, and the diameter of the inner bore 51, 51′ of said journals, substantially corresponding to the overall diameter of the retractable bushes 30, 30′, substantially comprised between 10 mm and 50 mm, the residual thickness of the wheel rims 52, 52′, corresponding to the difference between the outer diameter and the inner diameter of the concerned journal 30, 30′, preferably being from approximately 2 mm to 10 mm.

According to one preferred arrangement that may constitute a completely separate invention, each guide slot 50, 50′ may, as shown in FIGS. 1 to 4, follow a bent generatrix, crossing the primary axis (X₁X₁′), and more particularly comprising two segments 54, 55, 54′, 55′ forming an angle, preferably curved.

The first segment 54, 54′, which is advantageously open on the frontal face of the base 2, which faces the passenger compartment 8, will preferably be oriented obliquely relative to the baseplate 6 and therefore the support 7, here by an ascending incline.

Said first segment will preferably form an insertion segment, allowing the frontal engagement of the pedal 3, and more particularly the frontal engagement of the journals 31, 31′ supported by the yoke 32, on the base 2, and will allow them to be brought into the first position (X₁X₁′), for assembly of said pedal 3 on said base 2.

The width of said first segment 54, 54′ may be substantially constant, or on the contrary narrowing from the mouth toward the bend 56, 56′ of the guide slot 50, 50′, like a horn, to facilitate inserting and gradual axial centering of the yoke 32.

The second segment 55, 55′, which continues the first segment in a cul-de-sac form from the bent end 56, 56′ up to the abutment 53, 53′, will preferably form a clearing segment, which preferably extends substantially rectilinearly, or on the contrary curvilinearly, ascending and preferably substantially normal to the support 7, said clearing segment making it possible to lead the journals 31, 31′ from the first articulation portion (X₁X₁′) to the second articulation portion (X₂X₂′).

Thus, the generatrix of said second segment 55, 55′ of the guide slot 50, 50′ will preferably correspond to a trajectory followed by the tilting axis during its transfer T from the first position (X₁X₁′) to the second position (X₂X₂′).

In general, this generatrix may assume any form or any orientation that one skilled in the art may deem most suitable for a pedal retracting trajectory capable of guaranteeing optimal security for the driver in case of impact.

Furthermore, the width of the second segment 55, 55′ will preferably be substantially constant, and slightly larger than the diameter of the wheel rim 52, 52′, to within the functional rotational clearance,.

According to another alternative embodiment, one may choose not to guide the freed pedal precisely along a unique determined trajectory, but only to define the limitations of the possible movements of the pedal 3.

For this purpose, the second segments 55, 55′ may for example have an upwardly flared shape, the gradual increase in their width, here considered along the direction of said segment and moving away from the base plate 6, thus allowing the possibility of transverse movement, for example in the vicinity of several millimeters, between the wheel rims 32 and the inner edges of the guide slots 50, 50′.

Particularly preferably, the primary axis (X₁X₁′), and more generally the orifice 44, 44′ allowing the deployment and retraction of the retractable bushes 30, 30′, will be contained in the second segment 55, 55′, beyond the bend 56, 56′ relative to the mouth of the first segment, and more particularly directly and vertically below the second position (X₂X₂′).

Thus, the transfer T may be done by a direct and fast rectilinear rise of the yoke 32, which, once freed from the bushes 30, 30′, will not encounter any significant stress opposing its movement.

More generally, it will be noted that the slots 50, 50′ extend preferably generally, from their mouth to their abutment 53, 53′, with a substantially longitudinal “pushing in” component Y, parallel to the support 7, or even substantially parallel to the longitudinal direction of the arm 10, said component being horizontal by convention in FIGS. 2 to 4, and oriented in the direction going from the pad 11 toward the tilting axis, from the passenger compartment 8 toward the back of the pedal assembly 1.

This pushing in the component Y, in practice preferably oriented toward the top of the vehicle in view of the installation of the base 2 on the fire wall 7, advantageously favors the natural transfer of the yoke 32 from its first (X₁X₁′) to its second (X₂X₂′) position under the effect of the longitudinal thrust component, oriented from back to front, of the weight of the arm 10 and/or the control force F.

According to possible alternative embodiments diagrammed in FIGS. 10 and 11, the journals 31, 31′ (which may or may not contain bores 51, 51′) and the guide slots 50, 50′ may be arranged, in a conjugated manner, so as to form a dovetail-61 or T-62 shaped guide, so as to improve the guiding and retaining capacity of the pedal 3 by the base 2 upon the release of said pedal.

According to one preferred feature, in particular irrespective of the nature of the securing means, the pedal 3 is provided, as was described above, with a coupling member 12 designed to link the pedal 3 functionally to the actuator 4, and the securing means 20 are arranged so as to make it possible to preserve said functional control link between the pedal 3 and the actuator 4 after said securing means are activated in case of impact.

In other words, the securing means 20 will preferably be arranged to allow the release of the pedal 3 while ensuring maintenance of the main operating condition of the pedal assembly 1, by on the one hand preserving a functional tilting link between the pedal and the base, and on the other hand preserving the fastening and functional control link, here in compression, between the arm 10 of said pedal and the actuator 4.

For this purpose, the coupling member 12 will preferably be separate from the elements composing the primary axis (X₁X₁′), and offset relative to said primary axis, on the body of the arm 10.

Thus, in case of impact, the driver will benefit not only from the protection imparted by the retraction of the pedal, but also continuation of the functional capacities of the pedal assembly 1 allowing him to still exert some control over the vehicle after said impact, and more particularly to act on the brake control.

It will further be noted that, upon activation of the securing means 20, the bottom of the arm 10 may come to bear against the floor or fire wall 7 of the vehicle, and/or the arm 10 may remain bearing, advantageously tilt-bearing, on the actuator 4 by means of the coupling member 12, and that such bearing may advantageously favor the sliding of the tilting axis, and more particularly the rise of the journals 31, 31′, in the guide slots 50, 50′, under the thrust from the driver's foot.

Of course, the invention also relates to a subassembly 60 for retracting the tilting axis of a pedal assembly 1.

Preferably, as illustrated in FIG. 7, such a subassembly 60 comprises a radial lever 22 coupled, preferably by flats 48 or splines, to the central segment, preferably of the collar type, of a maneuvering rod 45, so as to be able to rotate said rod around its steering axis, substantially transverse to said lever, and which here is combined with the primary axis (X₁X₁′).

Said subassembly preferably also comprises a first bush 30 engaged, along its generator axis, on the maneuvering rod 4) and having, either on its radially inner face, or on the radially outer face, a helical linking member designed to allow the conversion of the rotational movement of the lever into an axial translational movement of said first bush.

Said subassembly further preferably comprises a second bush 30′ engaged, along its generator axis, on the maneuvering rod 45 across from the first bush and having, either on its radially inner face, or on its radially outer face, a helical linking member designed to allow the conversion of the rotational movement of the lever into an axial translational movement of said second bush, in a direction opposite that of the first bush.

As was described above, the first bush 30 and/or the second bush 30′ may either include rotational blocking members, of the flat type, etc. on its radially inner face cooperating with the maneuvering rod 45, while the helical linking member (thread or groove) will be formed on the radially outer surface to engage in the base 2, or, conversely, include rotational blocking members on the radially outer face and a helical linking member (male thread or female groove) on its inner face, to engage on a conjugated member of the maneuvering rod 45.

Thus, according to one preferred alternative, said subassembly 60 also comprises a first bush 30 engaged, along its generator axis, in a helical link on the first end of said maneuvering rod 45, the radially outer surface of said first bush 30 on the one hand offering one or more articulation surfaces 40, 41 that follow at least one cylinder portion with a substantially circular base, so as to embody a first primary axis element (X₁X₁′) allowing the articulation of the pedal 3 of the pedal assembly 1 on the base 2 of said pedal assembly, and on the other hand one or more guide surfaces 42, 43, of the flat or spline type, designed to cooperate with the base 2 of the pedal assembly 1 to block the rotation and allow the axial translation of said first bush 30.

Furthermore, the radially inner surface of said first bush is hollowed out by a helical groove 47 on which a conjugated helical thread 46 supported by the corresponding end segment of the maneuvering rod 45 meshes, so as to make it possible to force the translation R30 of said first bush 30 toward the central segment when the lever 22 rotates the rod 45 relative to the first bush.

According to the invention, the subassembly 60 also comprises, similarly and preferably symmetrically, a second bush 30′ engaged, along its generator axis, in a helical link on the second end of said maneuvering rod 45, opposite the first end relative to the central segment.

The radially outer surface of said second bush 30′ on the one hand offers one or more articulation surfaces 40′, 41′ that follow at least one cylinder portion with a substantially circular base, so as to embody a second primary articulation axis element of the pedal 3, coaxial to the first primary axis element, and on the other hand one or more guides surfaces 42′, 43′, of the flat or spline type, designed to cooperate with the base 3 of the pedal assembly to block the rotation and allow the axial translation of said second bush 30′.

The radially inner surface of the second bush 30′ is furthermore hollowed out by a helical groove 47′ on which a conjugated helical thread 46′, supported by the corresponding end segment of the maneuvering rod 45, meshes, said helical thread 46′ having a pitch which is preferably equal to the pitch of the thread that cooperates with the first bush, but having a reverse thread angle by comparison with the helical thread 46 that cooperates with the first bush 30, said thread 46′ thus making it possible to force the translation R30′ of the second bush 30′, in opposition to the first bush 30.

It will be noted that the subassembly 60 according to the invention, and more generally the general principle of axial retraction of the bushes 30, 30′ by screwing, according to a withdrawal movement preferably oriented toward the inside of the base 2, may optionally be implemented, according to one or another of the arrangements described in the preceding, within other types of pedal assemblies.

They may in particular serve simply to eliminate, in case of impact, the initial articulation of a pedal on a base, for example so as to allow the complete separation of the pedal in case of impact.

In other words, the technology according to the invention may be extended to other uses and different types of pedal assemblies, for example independently of the existence or absence of captive tilting axis transfer means, such as guide slots 50, 50′ and journals 31, 31′.

The assembly and the dynamic operation for securing of the pedal assembly 1 will now be described in preferred reference to FIGS. 1 to 6.

Initially, the pedal 3 is assembled on the pedal assembly 2, pivotably connected around the primary axis (X₁X₁′).

For this purpose, the pierced tab 49 of the lever 22 is inserted into the base 2, aligned with the orifices 44, 44′.

The bores 51, 51′ of the yoke 32 are next positioned aligned with said orifices 44, 44′, by grasping the pedal 3 by its arm 10, frontally inserting the journals 31, 31′ in their respective guide slots 50, 50′, then pushing the arm 10 so as to continue the inserting movement of the yoke 32 along said guide slots 50 and 50′.

The maneuvering rod 45, previously equipped with its pre-aligned bushes 30, 30′, is then laterally inserted through the first bore 51, then the first orifice 44, then the tab 49, then the second orifice 44′, then the second bore 51′ so as to produce the actual connection of the pedal 3 on the base 2, thereby embodying the primary axis (X₁X₁′).

Advantageously, to simplify the assembly operation, the two bushes 30, 30′ and the central segment (collar with flat) of the maneuvering rod 45 will preferably have transverse sections, normal to their shared generator axis, that are identical in terms of their shapes and dimensions, such that, provided that they are suitably oriented, the bushes 30, 30′ may pass axially through the pierced tab 49, while the central segment of the rod 45 may pass through the bores 51, 51′ and the wall of the base 2 through the orifices 44, 44′.

In this configuration, during normal operation, the bushes 30, 30′ act both as axis elements, on which the bores 51, 51′ swivel, and as latches that eliminate the degrees of transverse translational freedom so as to keep the tilting axis of the pedal 3 in its first fixed position (X₁X₁′) on the base 2.

When a frontal shock occurs that causes a sufficient deformation D of the fire wall 7 for the base to be driven toward the obstacle 23 purposely provided and for the paddle 24 of the lever 22 to collide with that obstacle 23 (FIG. 4), said lever 22 tilts, advantageously without encountering strong resistance, and in particular without it being necessary for it to break or deform, in particular plastically, any sacrificial part.

Using the flats 48, the lever 22 then rotates the maneuvering rod 45, for example over an angular sector comprised between 15° and 45° , or even 60° , relative to the base 2 and more particularly relative to the bushes 30, 30′, which are blocked in rotation around the primary axis (X₁X₁′) by the guides surfaces 42, 43, 42′, 43′ engaged in the orifices 44, 44′, against the inner walls of said orifices.

As a result, the helical threads 46, 46′ and the corresponding grooves 47, 47′ convert that rotation into a traction force that forces the return of the bushes 30, 30′ toward the inside of the base 2, by axial translation in the slide procured by the orifices 44.

The removal of the bushes 30, 30′ outside the bores 51, 51′ unhinges and unlocks the pedal 3, depriving it of its first primary axis (X₁X₁′).

Said primary axis is, however, simultaneously replaced by a second, floating secondary support axis, embodied by the rims 52, 52′ that are articulated in contact with the edges of the guide slots 50, 50′.

In other words, the seating of the pivot link is advantageously transferred from the radially inner bore 51, 51′ of the journals 31, 31′ of the yoke 32 to the radially outer rims 52, 52′ of said same journals, coaxial to said bore.

Owing to the degree of transverse translational freedom freed by the removal of the bushes 30, 30′, and under the effect of the weight of the arm 10 of the pedal and/or the control force F exerted by the driver's foot on the pad 11, the pedal 3 is pushed back in its entirety toward the floor and/or toward the front of the vehicle.

To accommodate this pushing back, the secondary floating support axis, and more particularly the journals 31, 31′, leave their first position coaxial to the primary axis (X₁X₁′) and slide in their respective guide slots 50, 50′, held captive by the limits set by said slots, until they come, hereby by progressing upward and toward the rear of the vehicle, due to the normal orientation of the base 2 relative to the slope of the fire wall, housed at the upper end of said guide slots, against the abutments 53, 53′, in a second position (X₂X₂′).

Although floating, the secondary support axis makes it possible to keep the pedal held captive by the base 2, and continues to offer, in particular when the rims 52, 52′ of the journals 31, 31′ are pressed against the concave abutments 53, 53′, a degree of tilting freedom that preserves the functionality of the pedal assembly 1.

Although the first pivot link procured by the bushes 30, 30′ may potentially be reconstructed during the subsequent repair of the vehicle, said first pivot link is in practice, during the accident, irreversibly lost when said bushes 30 and 30′ retract and the yoke 32 transfers its bearing on its wheel rims 52, 52′ and begins to slide while thus leaving the primary axis.

With regard to this, it will be noted that in case of accident, any repair of the pedal assembly must be prohibited as a precaution, and the pedal assembly must be replaced so as to avoid any uncertainty as to the safety, and more particularly the future robustness and reliability of the device.

Of course, the invention is in no way limited to one particular alternative embodiment, the person skilled in the art in particular being able to adapt, isolate or combine any of the features described above.

In particular, it is for example possible to consider adapting the subassembly 60 for retracting the bushes by screwing to any pedal assembly, irrespective of whether said pedal assembly is provided with a auxiliary axis making it possible to preserve a tilting link between the base and the pedal after retraction of said bushes.

Ultimately, the invention will make it possible, using simple and inexpensive parts, to produce a compact and lightweight pedal assembly, but which is particularly robust and reliable.

Said pedal assembly 1 will be particularly safe, and not very vulnerable to aging or seizing, in particular due to the fact that its securing means preferably have no sacrificial parts and/or elastic return members of the spring type, the lever 22 in fact preferably being mounted freely rotating on the base 2, to within the meshing resistance of the helical threads 46, 46′ and axial traction resistance of the bushes 30, 30′.

The compactness of the pedal assembly 1 will in particular result from sharing a single and same axis to form, using concentric parts superimposed in contact with each other, the primary tilting axis (by the bushes 30, 30′), the activating axis (bearing the lever 22), and the guided escape maneuvering axis (maneuvering rod 45).

Lastly, all of the component parts of the pedal assembly remaining captive of said pedal assembly during and after the latter is secured, no potential projectile is therefore released into the passenger compartment 8 in case of impact.

1. A pedal assembly comprising a base on which at least one pedal is pivotably articulated, said pedal being designed to control the operation of an actuator, said pedal assembly being provided with securing means designed to allow placement of the pedal in a secure configuration in the event an impact situation is detected, wherein said securing means are arranged so as to be able to cause, when activated in an impact situation, freeing of the tilting axis of the pedal and a captive transfer of said tilting axis relative to the base along at least one release component substantially transverse to the initial axial orientation of said tilting axis, so as to allow the release of the pedal while ensuring maintenance of a functional tilting link between said pedal and the base, the securing means comprising at least one primary axis element, which is fusible or retractable in case of impact, on which the pedal is articulated during normal operation, and at least one auxiliary axis element, separate from the primary axis element and designed to provide an emergency pivot link for said pedal with the base once the primary axis element is broken or retracted.

2. The pedal assembly according to claim 1, wherein the at least one primary axis element is formed by at least one retractable bush, on which the pedal is rotatably articulated during normal operation and which is designed to retract axially, in case of impact, depending on an triggering member, so as to free itself from the pedal.

3. The pedal assembly according to claim 2, wherein the triggering member includes a lever that is mounted tilting on the base and coupled to a maneuvering rod on which the retractable bush(es) are engaged, said maneuvering rod being arranged to be able to control the axial return of the retractable bush(es).

4. The pedal assembly according to claim 3, wherein the retractable bush(es) are slidingly mounted in the base and are outwardly provided with guide surfaces, of the flat, lug or spline type, arranged to cooperate with the walls of the base so as to block the rotation of said bush(es) around their axis (X₁X₁′) within said base, the retractable bush(es) each being axially engaged on the maneuvering rod, said maneuvering rod being provided with a helical thread designed to cooperate with a helical groove with a conjugated shape that is hollowed inside the considered bush, such that the lever can rotate the maneuvering rod and thus control the axial return, by screwing along the maneuvering rod, of the retractable bush(es).

5. The pedal assembly according to claim 3, wherein the retractable bush(es) are mounted axially slidingly on the maneuvering rod and inwardly provided with guide surfaces, of the flat, lug or spline type, arranged to cooperate with conjugated walls of said maneuvering rod so as to secure said bush(es) in rotation with said maneuvering rod around their shared axis, the retractable bush(es) being provided, on their radially outer surface, with a helical thread designed to cooperate with a helical groove with a conjugated shape that is hollowed inside said base, such that the lever can rotate the maneuvering rod and the bush(es) together and thereby control the axial return, by screwing in the base, of the retractable bush(es).

6. The pedal assembly according to claim 1, wherein the pedal is articulated on the base using a yoke whereof the two branches cooperate, on either side of said base, with a first primary axis element and with a second primary axis element, coaxial to the first primary axis element, respectively, and in that the securing means are arranged so as to be able to draw, simultaneously, the first and second primary axis elements toward each other, so as to retract them inside the base, between the branches of the yoke.

7. The pedal assembly according to claim 1, wherein the at least one auxiliary axis element is formed by a journal secured to the pedal, integral with the arm of said pedal, and which is housed in a guide slot hollowed out from one of the outer lateral faces of the base.

8. The pedal assembly according to claim 6, wherein the left and right branches of the yoke respectively bear a first journal and a second journal that are coaxial, oriented toward the base, and respectively engaged in a first left guide slot and a second right guide slot each hollowed on one of the corresponding left and right lateral faces of said base, said first and second journals each being pierced, along their generator axis, with a bore designed to receive and guide in rotation, during normal operation, the corresponding primary axis element so as to authorize and guide the tilting of the pedal, and in that the radially outer rim of each of said journals forms a cylindrical rim with a substantially circular base, coaxial to the bore, the diameter of which substantially corresponds to the width of the guide slot in which the journal is engaged, such that, in case of removal of the corresponding primary axis elements, the journals can slide transversely to their generator axis, captive along their respective slot, while preserving a degree of rotational freedom around said generator axis.

9. The pedal assembly according to claim 1, wherein the arm of the pedal comprises two sets of articulation members installed on the pedal at a distance one from the other, the articulation members of the first set, of the bore type, physically defining a first primary axis on the pedal and being designed to cooperate with the primary axis element(s) so as to initially allow the articulation of the pedal around said primary axis, the articulation members of the second set, of the journal type, define, on the same pedal, a second, reserve, auxiliary axis, at a fixed transverse distance from the first primary axis, and said articulation means of the second set being arranged to cooperate from the beginning with the base, jointly with the articulation members of the first set, so as to be able to take over instantaneously for the latter, and thus automatically replace the primary axis with the auxiliary axis, when retraction or destruction of the primary axis elements occurs.

10. The pedal assembly according to claim 1, wherein the pedal is provided with a coupling member designed to functionally link the pedal to the actuator and in that the securing means are arranged so as to allow the preservation, after they are activated in case of impact, of said functional control link between the pedal and the actuator.

11. A subassembly for retracting the tilting axis for a pedal assembly according to claim 1, said subassembly comprising:
a radial lever coupled, by flats or splines, to the central segment of the maneuvering rod, so as to be able to rotate said maneuvering rod around its main axis, substantially transverse to the lever,
a first bush that is engaged, along its generator axis, on the maneuvering rod and having, either on its radially inner face or on its radially outer face, a helical linking member designed to allow the conversion of the rotational movement of the lever into an axial translational movement of said first bush,
a second bush that is engaged, along its generator axis, on the maneuvering rod across from the first bush and having, either on its radially inner face or on its radially outer face, a helical linking member designed to allow the conversion of the rotational movement of the lever into an axial translational movement of said second bush, in a direction opposite that of the first bush.

12. The subassembly for retracting the tilting axis according to claim 11, wherein it comprises:
a radial lever coupled, by flats or splines, to the central segment of the maneuvering rod, so as to be able to rotate said maneuvering rod around its steering axis, substantially transverse to said lever,
as well as a first bush engaged, along its generator axis, in a helical link on the first end of said maneuvering rod, the radially outer surface of said first bush having articulation surfaces that follow at least one cylinder portion with a substantially circular base, so as to embody a first primary axis element making it possible to articulate the pedal on the base of said pedal assembly, and one or more guide surfaces, of the flat or spline type, designed to cooperate with the base of the pedal assembly to block the rotation and allow the axial translation of said first bush, the radially inner surface of said first bush furthermore being hollowed out by a helical groove on which a conjugated helical thread meshes, said helical thread being supported by the corresponding end segment of the maneuvering rod, so as to make it possible to force the translation of said first bush toward the central segment when the lever rotates the maneuvering rod relative to the first bush,
as well as a second bush that is slipped, along its generator axis, in a helical link on the second end of said maneuvering rod, the radially outer surface of said second bush offering one or more articulation surfaces that follow at least one cylinder portion with a substantially circular base, so as to embody a second primary axis element for articulating the pedal, coaxial to the first primary axis element, and one or more guide surfaces, of the flat or spline type, designed to cooperate with the base to block the rotation and allow the axial translation of said second bush, the radially inner surface of said second bush furthermore being hollowed out by a helical groove on which a conjugated helical thread meshes, said helical thread being supported by the corresponding end segment of the maneuvering rod, but having a reverse thread angle with respect to the thread angle of the thread which cooperates with the first bush, thus making it possible to force the translation of the second bush in opposition to the first bush.

13. A vehicle, equipped with a pedal assembly, according to claim 1.
